(19) United States
(12) Patent Application Publication
(10) Pub. No.: US 2005/0162424 A1
(43) Pub. Date: Jul. 28, 2005

(54) Computer product, session management method, and session management apparatus

(76) Inventors: Yuko Imai, Kawasaki (JP); Takashi Fukagawa, Kawasaki (JP)

Correspondence Address: Rosenman & Colin, LLP;IP Department, 575 Madison Street, New York, NY, 10022-2858, US

(21) Appl. No.: 11/070,715

(22) Filed: Mar. 2, 2005

Related U.S. Application Data
(63) Continuation of application No. PCT/JP03/01342, filed on Feb. 7, 2003.

(51) Int. Cl. G06T 11/20

(52) U.S. Cl. 345/441

(57) ABSTRACT

A transmission device includes a physical port and a plurality of logical ports that receive a control frame from a monitor/control device on in a network. The control frame includes an ID of a destination device and a control code. A communication controller in the transmission device appends to the received control frame, source port information (an ID of the physical port and an ID of the logical port at which the control frame is received), and local device information. If the control frame is meant for the local device, the communication controller carries out the process according to the control code in the frame. If the control frame is meant for a device other than the local device, the communication controller appends the source port information and the source device ID to the control frame and sends the control frame to the other device.

### BACKGROUND OF THE INVENTION

1) Field of the Invention

The present invention relates to management and establishment of sessions in a network.

2) Description of the Related Art

Networks of devices such as computers, printers have become common now-a-days. This has necessitated monitoring and control of transmission devices in the network. The monitoring and control of the transmitting devices are carried out by monitor/control devices.

Japanese Patent Laid-Open Publication No. 2001-144760 discloses a structure (monitor/control system) for session establishment by establishment of logical communication channel between the transmission devices and the monitor/control devices to carry out data exchange for monitoring/controlling the transmission devices.

FIG. 12 is a block diagram of a conventional monitor/control system. The conventional monitor/control system includes a plurality of transmission devices 20₁ through 20₄ connected in a ring to form a network, and a plurality of monitor/control devices 10₁ through 10₃ that monitor and/or control the transmission devices 20₁ through 20₄.

The transmission device 20₁ has a plurality of physical ports 21₁ through 21₃, and the monitor/control devices 10₁ through 10₃ are respectively connected to these physical ports. An identifier (ID) is set for each of the physical ports 21₁ through 21₃. The transmission device 20₁ has a transmission channel interface (I/F) 22, and the transmission devices 20₂ and 20₄ are connected to this transmission channel interface (I/F) 22.

The transmission device 20₁ includes a communication controller 23 that controls receiving control frames from and sending response frames to the monitor/control devices 10₁ through 10₃ or the other transmission devices 20₂ through 20₄.

The transmission device 20₁ includes a session managing unit 24 that manages conditions required for session management (hereinafter, “session conditions”) to enable the monitor control devices 10₁ through 10₃ to monitor and/or control as well as transmission of the control frames and response frames.

The transmission device 20₁ includes a plurality of OPS processors 25₁ through 25ₙ that process the control requests and send the response frames based on the process results. An identifier is set for each of the OPS processors 25₁ through 25ₙ.

Except the absence of the physical ports 21₁ through 21₃, the transmission devices 20₂ through 20₄ have the same structure as the transmission device 20₁. An identifier is set for each of the transmission devices 20₁ through 20₄.

An operator decides upon and selects, through the monitor/control device 10₁, one transmission device from among the transmission devices 20₁ through 20₄ for carrying out monitoring and/or control. It is assumed here that and the operator selects the transmission device 20₁.

The monitor/control device 10₁ then creates a control frame to be sent to the transmission device 20₁. An exemplary control frame is shown in FIG. 13A. The control frame includes a destination device ID, a destination port ID, and data.

Here, there is a need to establish a session between the transmission device 20₁ and the monitor/control device 10₁. Accordingly, the destination device ID, the destination port ID, and the data in the control frame are set as follows. Precisely, the identifier of the transmission device 20₁, which is the device to be monitored and/or controlled, is set in the destination device ID. The identifier of the OPS processor 25₁ through 25ₙ that will establish the session is set in the destination port ID. A control code and control parameters that indicate session establishment are set in the data.

The monitor/control device 10₁ sends the control frame shown in FIG. 13A to the transmission device 20₁. Precisely, the monitor/control device 10, sends the control frame to the communication controller 23 via the physical port 21₁.

The communication controller 23 of the transmission device 20₁ appends, as shown in FIG. 13B, data to the control frame. This data includes a source device ID and a source port ID. The source device ID is an identifier of the local device (i.e., transmission device 201). The source port ID is the identifier of the physical port at which the control frame is received. Since the frame is received at the physical port 21₁, the source device ID in this case will be the identifier of the physical port 21₁.

The communication controller 23 then compares the destination device ID in the control frame with the local device ID to determine whether the control frame is meant for the local device. Precisely, if the destination device ID and the local device ID are same, then it is determined that the control frame is determined to be meant for the local device. If the control frame is determined to be meant for the local device, the communication controller 23 sends the control frame shown in FIG. 13B to the session managing unit 24.

The session managing unit 24 refers to the control code of the data in the control frame and determines if the control frame is meant for session establishment. If the control frame is meant for session establishment, the session managing unit 24 determines whether the OPS processor 25₁ through 25ₙ specified in the destination port ID of the control frame is free, that is, not engaged in a session.

If the specified OPS processor is found to be free, the session managing unit 24 sends the control frame to the specified OPS processor. The specified OPS processor then carries out the control process based on the control code in the control frame, creates a response frame that includes the control process result, and sends the response frame to the communication controller 23.

The communication controller 23 sends the response frame to the monitor/control device 10₁ via the physical port 21₁. Thus, a session is established between the monitor/control device 10₁ and the transmission device 20₁.

However, conventionally, plural physical ports are required in the transmission device 20₁. This results in an increase in the size of the transmission device 20₁. Furthermore, one physical port is assigned per monitor/control device. As a result, the number of sessions that can be established per monitor/control device is limited to one.

### SUMMARY OF THE INVENTION

It is an object of the present invention to at least solve the problems in the conventional technology.

A session management method according to an aspect of the present invention includes receiving a frame that includes destination device information and control information; determining whether the frame received is received from a monitor/control device, and appending, if it is determined that the frame received is received from the monitor/control device, port information and local device information to the frame, the port information being information pertaining to a physical port and one of a plurality of logical ports, the logical ports being provided corresponding to the physical port for establishing a plurality of sessions; determining based on the destination device information in the frame whether a destination of the frame received is a local device or a device other than the local device, executing a process according to the control information if it is determined that the destination of the frame is the local device, and appending the port information and the local device information to the frame and transmitting the frame to the other device if it is determined that the destination of the frame is a device other than the local device.

A session management apparatus according to another aspect of the present invention includes a receiving unit that receives a frame that includes destination device information and control information; an appending unit that determines whether the frame received by the receiving unit is received from a monitor/control device, appends, if it is determined that the frame received is received from the monitor/control device, port information and local device information to the frame, the port information being information pertaining to a physical port and one of a plurality of logical ports, the logical ports being provided corresponding to the physical port for establishing a plurality of sessions; and a control unit that determines based on the destination device information in the frame whether a destination of the frame received is a local device or a device other than the local device, executes a process according to the control information if it is determined that the destination of the frame is the local device, and appends the port information and the local device information to the frame and transmits the frame to the other device if it is determined that the destination of the frame is the device other than the local device.

A computer-readable recording medium according to still another aspect of the present invention stores therein a computer program that implements the above method on a computer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a monitor/control system according to an embodiment of the present invention;

FIG. 2 is an exemplary port ID table;

FIG. 3 is an exemplary session management table;

FIG. 4 is an exemplary control command table;

FIG. 5 is a sequence drawing of the operation of the monitor/control system shown in FIG. 1;

FIG. 6 is a flowchart of the operation of a communication controller shown in FIG. 1;

FIG. 7 is a flowchart of the operation of a session managing unit shown in FIG. 1;

FIG. 8 is a drawing illustrating the correspondence between frame data and the session management table;

FIG. 9 is an exemplary control frame according to the present embodiment;

FIG. 10 is an exemplary response frame according to the present embodiment;

FIG. 11 is a functional block diagram of a computer system that implements the method according to the present embodiment;

FIG. 12 is a block diagram of a conventional monitor/control system; and

FIG. 13 is an exemplary control frame used in the conventional monitor/control system.

### DETAILED DESCRIPTION

Exemplary embodiments of the present invention are explained next with reference to the accompanying drawings.

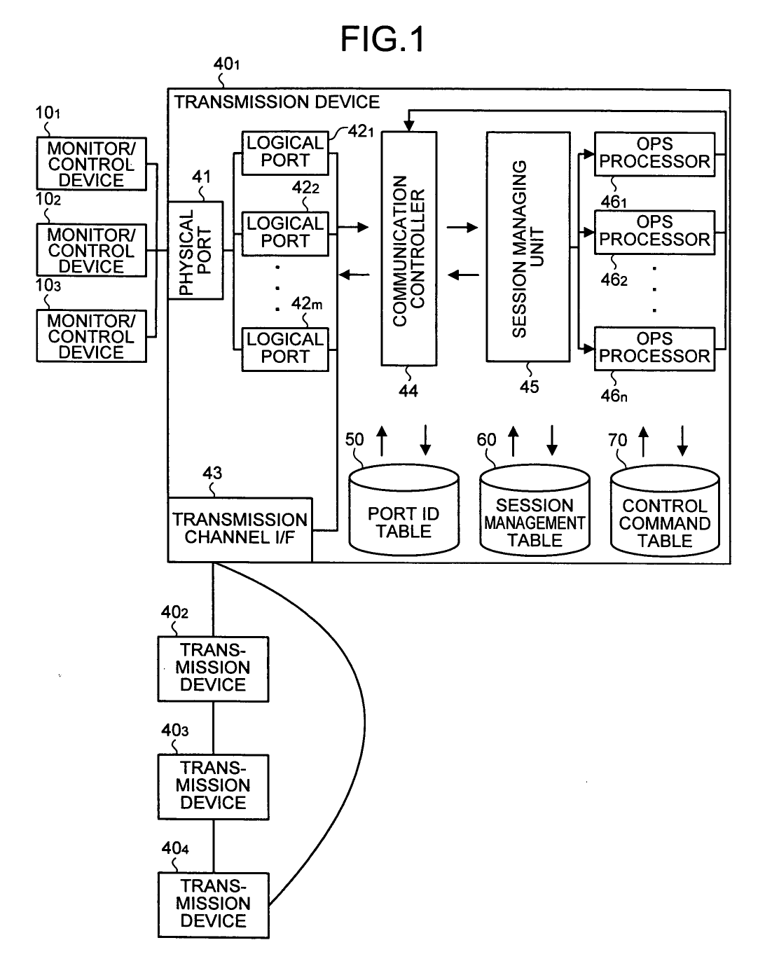

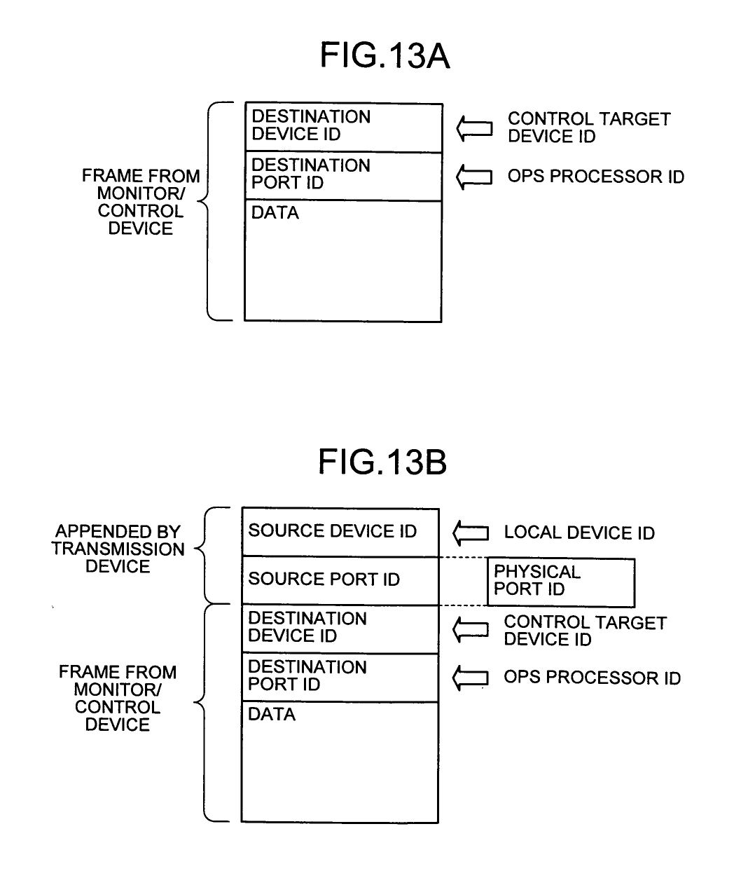

FIG. 1 is a block diagram of a monitor/control system according an embodiment of the present invention. The parts in FIG. 1 that are identical to those in FIG. 13 have been assigned the same reference numerals. The monitor/control system shown in FIG. 1 includes a plurality of transmission devices 40₁ through 40₄ in place of the transmission devices 20₁ through 20₄ in FIG. 13.

The transmission devices 40₁ through 40₄ are connected in a ring to form a network. The monitor/control devices 10₁ through 10₃ that monitor and/or control the transmission devices 40₁ through 40₄ are connected to the transmission devices 40₁.

The transmission device 40, has only one physical port 41. All the monitor/control devices 10₁ through 10₃ are connected to the transmission devices 40₁ via this physical port 41. The physical port 41 has m, where m is a positive integer, logical ports 42₁ through 42ₘ.

An identifier, i.e., physical port ID, is set for the physical port 41. An identifier, i.e., logical port ID, is set for each of the logical ports 42, through 42ₘ. The logical ports 42₁ through 42ₘ are set for a plurality of sessions. The transmission devices 40₁ includes a transmission channel I/F 43, and the transmission devices 40₂ and 40₄ are connected to the transmission devices 40, via this transmission channel I/F 43.

The transmission device 40, includes a communication controller 44. This communication controller 44 controls receiving control frames from and sending response frames to the monitor/control devices 10₁ through 10₃ or other transmission devices 40₂ through 40₄.

The transmission device 40₁ includes a session managing unit 45. This session managing unit 45 manages conditions required for session management (hereinafter, “session conditions”) to enable the monitor control devices 10₁ through 10₃ to monitor and/or control as well as transmission of the control frames and response frames.

The transmission device 40₁ includes a plurality of OPS processors 46₁ through 46ₙ. These OPS processors 46₁ through 46ₙ process the control requests and send the response frames based on the process results. An identifier is set for each of the OPS processors 46₁ through 46ₙ.

Except that the transmission devices 40₂ through 40₄ have no physical port or logical ports, the transmission devices 40₂ through 40₄ have the same structure as the transmission device 40₁. An identifier is set for each of the transmission devices 40₁ through 40₄.

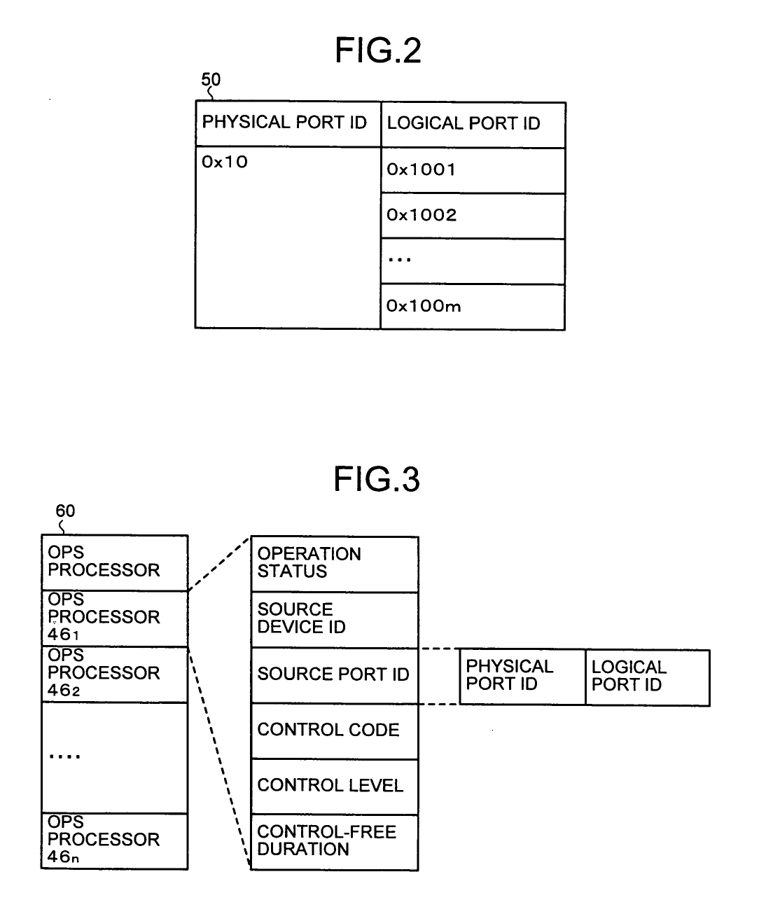

The transmission device 40₁ includes a port ID table 50. This port ID table 50 manages the identifiers set for the physical port 41 and the logical ports 42₁ through 42ₘ. FIG. 2 is an example of contents of the port ID table 50. The port ID table 50 includes two fields: physical port ID and logical port ID. The identifier of the physical port 41 is set in the physical port ID. The identifiers of the logical ports 42₁ through 42ₘ are set in the field logical port ID.

Referring back to FIG. 1, the transmission device 40, includes a session management table 60. This session management table 60 manages the session conditions between the transmission device 40₁ and the monitor/control devices 10₁ through 10₃. FIG. 3 is an example of contents of the session management table 60. The session management table 60 includes for each of the OPS processor 46, through 46ₙ: operation status, source device ID, source port ID (physical port ID and logical port ID), control code, control level, and control-free duration.

The operation status indicates whether a session is established or released. The source device ID indicates the identifier of a control frame source device. The source port ID indicates either the physical port ID of the physical port 41 physically connected to the control frame source device or the logical port ID of one of the logical ports 42, through 42ₘ connected logically to the control frame source device.

The control code indicates the control code of a control command included in the control frame. The control level indicates the level of control limits of the OPS processor 46₁ through 46ₙ. The control-free duration indicates the duration when no control is carried out by the monitor/control device.

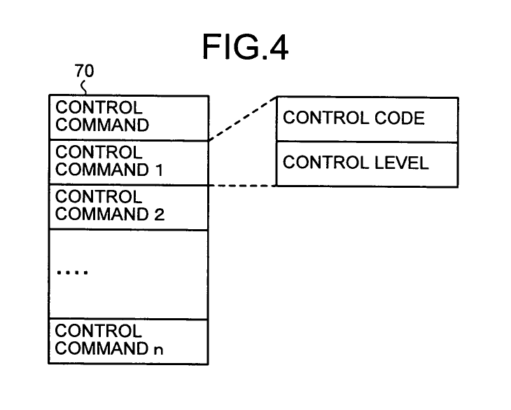

Referring back to FIG. 1, the transmission device 40₁ includes a control command table 70. The control command table 70 sets, for each of the control commands 1 through n, a control code and a control level. FIG. 4 is an example of the contents of the control command table 70.

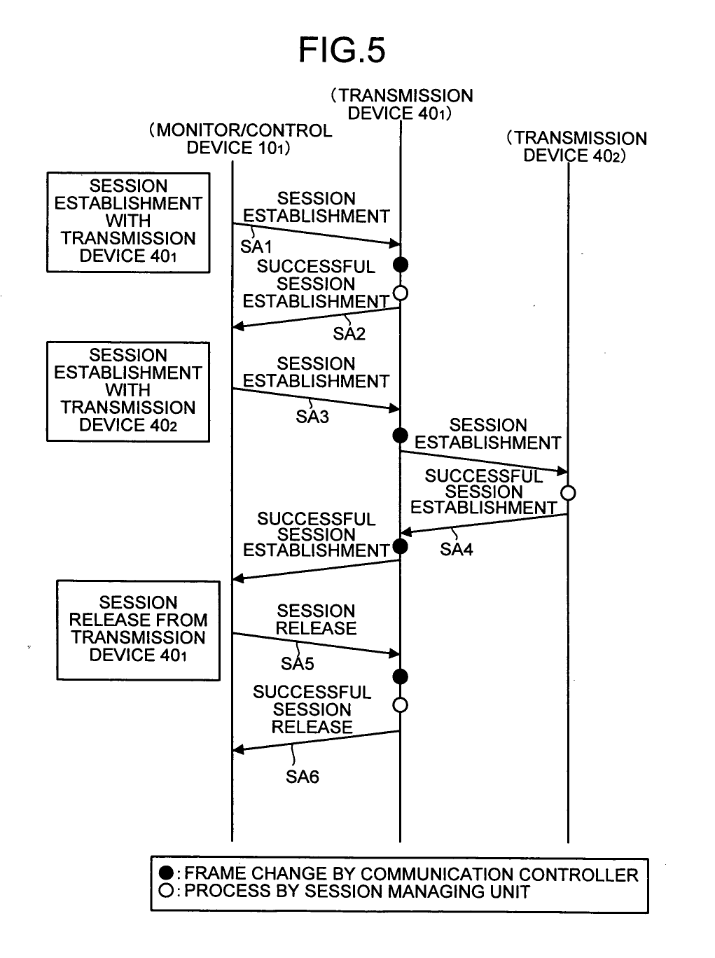

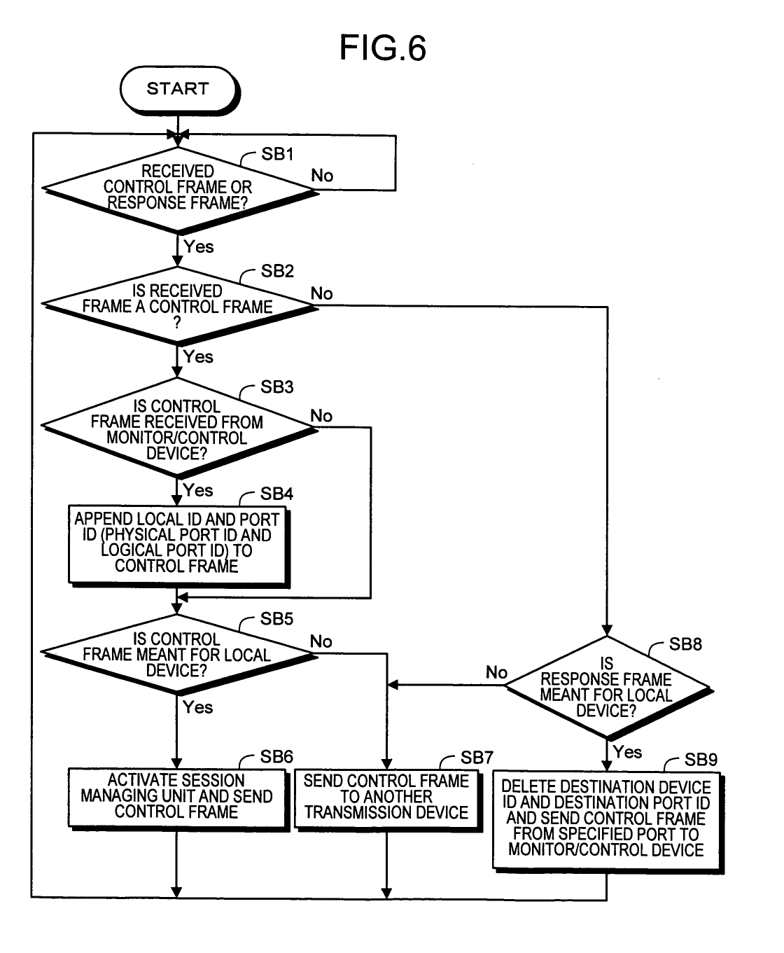

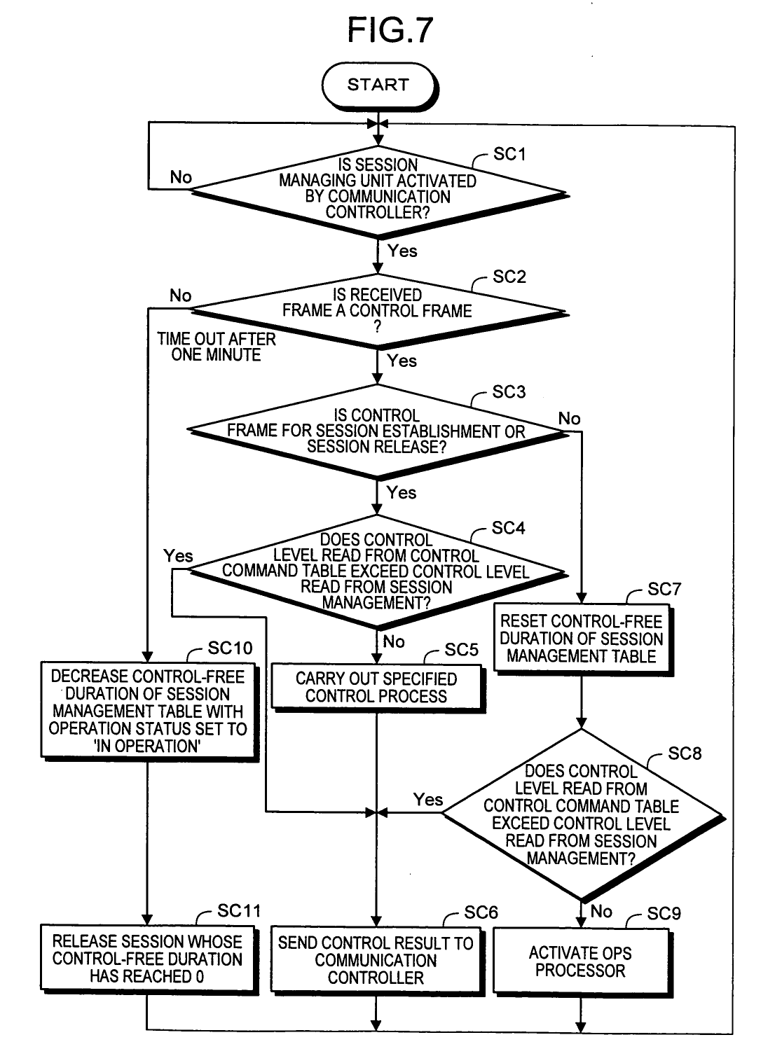

The operation of the monitor/control system is explained next with reference to FIG. 5 through FIG. 10. FIG. 5 is a sequence drawing of the operation of the monitor/control system. FIG. 6 is a flowchart of the operation of the communication controller 44. FIG. 7 is a flowchart of the operation of the session managing unit 45.

The operations involved in session establishment between the monitor/control device 10, and the transmission device 40₁ followed by session establishment between the monitor/control device 10₁ and the transmission device 40₂ when transmission device 40₁ is still in session with the monitor/control device 10₁ and session release between the monitor/control device 10₁ and the transmission device 40₁ are explained next with reference to FIG. 5.

At step SA1, the monitor/control device 10₁ sends to the transmission device 40₁ a request for session establishment. At step SA2, a session is successfully established between the monitor/control device 10₁ and the transmission device 40₁. At step SA3, the monitor/control device 10₁, while still in session with the transmission device 40₁, sends to the transmission device 40₂ a request for session establishment via the transmission device 40₁. At step SA4, a session is successfully established between the monitor/control device 10₁ and the transmission device 40₂.

At step SA5, the monitor/control device 10₁ sends to the transmission device 40₁ a request to release the session. At step SA6, the session between the monitor/control device 10₁ and the transmission device 40₁ is successfully released.

The operation described above is explained in detail with reference to FIG. 6 through FIG. 10. At step SB1 in FIG. 6, the communication controller 44 determines whether either a control frame or a response frame has been received from the physical port (logical ports 42₁ through 42ₘ) 41 or the transmission channel I/F 43. If the answer at step SB1 is “No”, the communication controller 44 repeats step SB1.

At step SC1 of FIG. 7, the session managing unit 45 determines whether it has been activated by the communication controller 44. If the answer at step SC1 is “No”, session managing unit 45 repeats step SC1.

An operator decides upon and selects, through the monitor/control device 10₁, one transmission device from among the transmission devices 40₁ through 40₄ for carrying out monitoring and/or control. It is assumed here that and the operator selects the transmission device 40₁.

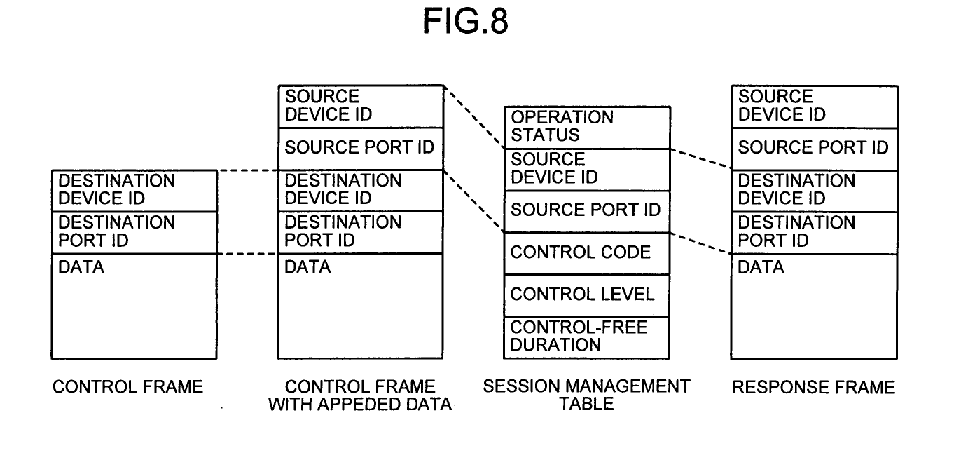

The monitor/control device 10, then creates a control frame to be sent to the transmission device 40₁. An exemplary control frame is shown in FIG. 8. The control frame includes a destination device ID, a destination port ID, and data.

Here, there is a need to establish a session between the transmission device 40, and the monitor/control device 10₁. Accordingly, the destination device ID, the destination port ID, and the data in the control frame are set as follows. Precisely, the identifier of the transmission device 40₁, which is the monitor/control target device, is set in the destination device ID. The identifier of the OPS processor 46₁ through 46ₙ that will establish the session is set in the destination port ID. A control code and control parameters that indicate session establishment are set in the data.

The monitor/control device 10, sends the control frame shown in FIG. 8 to the transmission device 20₁. Precisely, the monitor/control device 10, sends the control frame to the communication controller 44 via the physical port 41 and allocated to a logical port that is free from among the logical ports 42₁ to 42m. It is assumed here that the logical port 42₁ is a free port.

If the control frame is received, the answer at step SB1 shown in FIG. 6 will be “Yes”. When the answer at step SB1 is “Yes”, the communication controller 44 executes step SB2. At step SB2, the communication controller 44 determines whether the received frame is a control frame. Since, the answer at step SB2 is “Yes” in this case, the communication controller 44 executes step SB3.

At step SB3, the communication controller 44 determines whether the control frame has been received from the monitor/control device (any one of the monitor/control devices 10₁ through 10₃). Since, the answer at step SB3 is “Yes” in this case, the communication controller 44 executes step SB4. If the answer at step SB3 is “No”, the communication controller 44 executes step SB5.

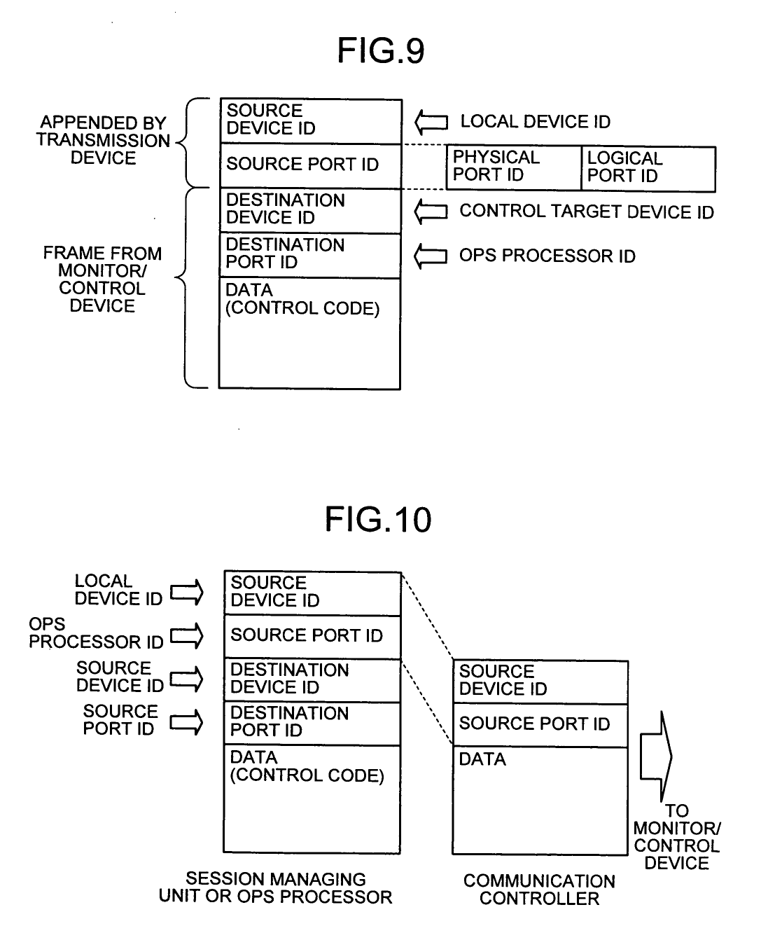

At step SB4, the communication controller 44 appends data to the control frame (see FIGS. 8 and 9). This data includes a source device ID and a field source port ID. The source device ID is an identifier of the local device (i.e., transmission device 401). The source port ID is an identifier of the physical port and the logical port at which the control frame is received. Since the control frame is received via the physical port 41 and the logical port 42₁, the physical port ID of the physical port 41 and the logical port ID of the logical port 42₁ are set in the source port ID. The communication controller 44 retrieves the physical port ID of the physical port 41 and the logical port ID of the logical port 42₁ from the port ID table 50 (see FIG. 2).

At step SB5, the communication controller 44 compares the destination device ID in the control frame with appended data (see FIGS. 8 and 9) with the local device ID to determine whether the control frame is meant for the local device. Since the answer is “Yes” in this case, the communication controller 44 executes step SB6.

At step SB6, the communication controller 44, activates the session managing unit 45 and sends to the session managing unit 45 the control frame with the appended data, and carries out the determination process of step SB1.

Upon being activated, since the answer at step SC1 is “Yes”, the session managing unit 45 executes step SC2. At step SC2, the session managing unit 45 determines whether the received frame is a control frame. Since frame received from the communication controller 44 is a control frame with the appended data (see FIGS. 8 and 9), the answer at step SC2 is “Yes” and the session managing unit 45 executes step SC3.

If the answer at step SC2 is “No” (that is, if time out occurs because no control frame is received in one minute), the session managing unit 45 executes step SC10. At step SC10, the session managing unit 45 decreases by one minute the control-free duration in the session management table 60 in which the operation status is set to ‘In session’. At step SC11, the session managing unit 45 releases the session in which the control-free duration has reached 0.

At step SC3, the session managing unit 45 refers to the control code of the received control frame and determines whether the control frame is for session establishment or session release. Since the control frame is for session establishment in this case, the answer at step SC3 is “Yes” and session managing unit 45 executes step SC4.

If the answer at step SC3 is “No”, the session managing unit 45 executes step SC7 in which it resets (to, say, 15 minutes) the control-free duration of the session management table 60 (see FIG. 3). At step SC8, the session managing unit 45 determines whether the control level read from the control command table 70 exceeds the control level read from the session management table 60.

If the answer at step SC8 is “No”, the session managing unit 45 executes step SC9. At step SC9, the session managing unit 45 activates the OPS processor 46₁ through 46ₙ. This activation causes the OPS processor 46₁ through 46ₙ to be in a stand-by mode to receive the control frame from the session managing unit 45. Upon receiving the control frame from the session managing unit 45, the OPS processor 46₁ through 46ₙ carries out the control process according to the control code in the control frame, creates a response frame (see FIG. 10) by setting the control result in the data field of the response frame, and sends the response frame to the communication controller 44.

At step SC4, the session managing unit 45 reads the control level of the control code included in the control frame from the control command table 70 (see FIG. 4), as well as the control level of the OPS processor 46₁ through 46ₙ specified by the destination port ID of the control frame from the session management table 60 (see FIG. 3), and determines whether the control level read from the control command table 70 exceeds the control level read from the session management table 60.

If the answer at step SC4 is “No”, the session managing unit 45 executes step SC5. At step SC5, the session managing unit 45 sets the operation status of the session management table 60 (see FIG. 8) to ‘In session’, and sets the source device ID and the source port ID of the control frame with the appended data to the source device ID and the source port ID of the session management table 60, and establishes a session.

At step SC6, the session managing unit 45 creates a response frame by setting, as shown in FIGS. 8 and 10, the local device ID in source device ID, the OPS processor ID in source port ID, and the destination device ID and the destination port ID included the control frame set in the session management table 60 in the fields Destination device ID and Destination port ID, respectively. The session managing unit 45 then sends the response frame to the communication controller 44.

Upon receiving the response frame (see FIG. 10) from the session managing unit 45, since the answer at step SB1 is “Yes”, the communication controller 44 executes step SB2. At step SB2, the communication controller 44 determines whether the received frame is a control frame. Since the received frame is a response frame, the answer at step SB2 is “No” and the communication controller 44 executes step SB8.

At step SB8, the communication controller 44 compares the source device ID in the response frame shown in FIG. 10 with the local device ID to determine whether the response frame is meant for the local device. Since the answer at step SB8 is “Yes” in this case, the communication controller 44 executes step SB9.

At step SB9, the communication controller 44 deletes from the response frame (see FIG. 10) the destination device ID and the destination port ID, sends the remaining response frame (see FIG. 10) from the specified port (say, the logical port 42₁ and the physical port 41) to the monitor/control device 10₁, and carries out the determination process of step SB1.

If the answer at step SB8 is “No”, the communication controller 44 goes to step SB7 in which it sends the response frame to another transmission device (any of the other transmission devices 40₂ through 40₄), and then carries out the determination process of step SB1.

While a session is in progress between the monitor/control device 10₁ and the transmission device 40₁, the operator selects, say, the transmission device 40₂ as the monitor/control target device through the monitor/control device 10₁.

Once the transmission device 40₂ is selected as the monitor/control target device, the monitor/control device 10, creates a control frame shown in FIG. 8 to be sent to the transmission device 40₂.

For establishing a session between the transmission device 40₂ and the monitor/control device 10₁, the identifier of the transmission device 40₂, which is the monitor/control target device, is set in the Destination device ID field of the control frame, the identifier of the OPS processor (not shown) of the transmission device 40₁ that will establish the session is set in the Destination port ID field of the control frame, and the control code and the control parameters that indicate session establishment are set in the data field of the control frame.

The control frame (see FIG. 8) sent from the monitor/control device 10₁ is received by the communication controller 44 via the physical port 41 and allocated to, for instance a free logical port 42₂.

Upon receiving the control frame, since the answer at step SB1 shown in FIG. 6 is “Yes”, the communication controller 44 executes step SB2. At step SB2, the communication controller 44 determines whether the received frame is a control frame. Since the frame the communication controller 44 has received is a control frame, the answer at step SB2 is “Yes”, and the communication controller 44 executes step SB3.

At step SB3, the communication controller 44 determines whether the control frame has been received from the monitor/control device (any one of the monitor/control devices 10₁ through 10₃). Since the answer at step SB3 is “Yes”, the communication controller 44 executes step SB4.

At step SB4, the communication controller 44 appends to the control frame with the appended data (see FIGS. 8 and 9), the field source device ID and sets in it the local device ID, and the field source port ID and sets in it the identifier of the physical port from which the control frame is received (in this case, the physical port ID of the physical port 41 and the logical port ID of the logical port 42₂). The communication controller 44 gets the port ID (the physical port ID of the physical port 41 and the logical port ID of the logical port 42₂) from the port ID table 50 (see FIG. 2).

At step SB5, the communication controller 44 compares the destination device ID in the control frame shown in FIGS. 8 and 9 with the local device ID to determine whether the control frame is meant for the local device. The answer at step SB5 is “No” in this case and the communication controller 44 executes step SB7.

At step SB7, the communication controller 44 sends the control frame to the transmission device 40₂ via the transmission channel I/F 43. Upon receiving the control frame, the transmission device 40₂ creates a response frame as described earlier, and sends the response to the transmission device 40₁.

Upon receiving the response frame from the transmission device 40₂ via the transmission channel I/F 43, the communication controller 44 carries out the determination process of step SB1. Since the answer at step SB1 is “Yes”, the communication controller 44 executes step SB2. Since the received frame is not a control frame but a response frame, the answer at step SB2 is “No” in this case, and the communication controller 44 executes step SB8.

At step SB8, the communication controller 44 compares the destination device ID in the response frame with the local device ID to determine whether the response frame is meant for the local device.

Since the answer at step SB8 is “Yes”, the communication controller 44 executes step SB9. At step SB9 the communication controller 44 deletes from the response frame the destination device ID and the destination port ID, sends the remaining response frame from the specified port (for instance, the logical port 42₂ and the physical port 41) to the monitor/control device 10₁, and carries out the determination process of step SB1.

Once the response frame is received by the monitor/control apparatus 10₁, the session is established. In other words, the instant the response frame is received by the monitor/control device 10₁, the monitor/control device 10₁ has a session established with both the transmission devices 40₁ and 40₂ via a single physical port (logical ports 42₁ and 42₂).

The operator then creates a control frame (see FIG. 8) to be used for releasing the session between the monitor/control device 10, and the transmission device 40₁ through 40₄.

To release the session between the transmission device 40₁ and the monitor/control device 10₁, the identifier of the transmission device 40₁ is set in the Destination device ID field of the control frame, the identifier of the OPS processor 46₁ through 46ₙ that establishes the session is set in the Destination port ID field of the control frame, and the control code and the control parameters that indicate session release are set in the data field of the control frame.

The control frame (see FIG. 8) sent from the monitor/control device 10₁ is received by the communication controller 44 via the physical port 41, and allocated to the logical port 42₁.

The communication controller 44 then performs the determination process of step SB1. Since the answer at step SB1 is “Yes”, the communication controller 44 executes step SB2 to determine whether the received frame is a control frame.

Since the answer at step SB2 is “Yes”, the communication controller 44 executes step SB3. At step SB3 the communication controller 44 determines whether the control frame has been received from the monitor control device (any one of the monitor/control devices 10₁ through 10₃).

Since the answer at step SB3 is “Yes”, the communication controller 44 executes step SB4. At step SB4 the communication controller 44 appends to the control frame with the appended data (see FIG. 8 and FIG. 9), the source device ID, which is the local device ID, and the source port ID, which is the identifier of the physical port from which the control frame is received (in this case, the physical ID of the physical port 41 and the logical ID of the logical port 42₁). The communication controller 44 gets the port ID (the physical port ID of the physical port 41 and the logical port ID of the logical port 42₁) from the port ID table 50 (see FIG. 2).

At step SB5, the communication controller 44 compares the destination device ID in the control frame with the local device ID to determine whether the control frame is meant for the local device.

Since the answer at step SB5 is “Yes”, the communication controller 44 executes step SB6. At step SB6, the communication controller 44, activates the session managing unit 45 and sends to the session managing unit 45 the control frame with the appended data, and carries out the determination process of step SB1.

Upon being activated, the session managing unit 45 carries out the determination process of step SC1. Since the answer at step SC1 is “Yes”, the communication controller 44 executes step SC2. At step SC2, the session managing unit 45 determines whether the received frame is a control frame. Since the frame received from the communication controller 44 is a control frame with the appended data, the answer at step SC2 is “Yes”, and the session managing unit 45 executes step SC3.

At step SC3, the session managing unit 45 refers to the control code of the received control frame and determines whether the control frame is for session establishment or session release. Since the control frame is for session release in this case, the answer at step SC3 is “Yes” and session managing unit 45 executes step SC4.

At step SC4, the session managing unit 45 determines, in the manner described above, whether the control level read from the control command table 70 exceeds the control level read from the session management table 60. Since, the answer at step SC4 is “Yes” in this case, the session managing unit 45 executes step SC6. At step SC6, the session managing unit 45 sends the control result to the communication controller 44.

To sum up, according to the present embodiment, it is first determined whether the control frame that is received is from any of the monitor/control devices 10₁ through 10₃. If so, the source device ID and the source port ID (the physical port ID as well as the logical port ID) of the physical port 41 that receives the control frame and one of the plural logical ports 42₁ through 42ₘ provided for plural sessions in the physical port 41 are appended to the control frame. If the control frame is meant for the local device, the process according to the control code is carried out. If the control frame is meant for another transmission device, the source device ID and the source port ID are appended to the control frame, and the control frame is sent to the relevant transmission device. Thus, physically less space is required since only one physical port 41 is used.

According to the present embodiment, upon receiving another control frame from the monitor/control device that already has a session established with a transmission device, the source port ID of the physical port 41 and any of the free plural logical ports and the source device ID are appended to the control frame. Thus, plural sessions can be established per monitor/control device.

According to the present embodiment, as explained in steps SC10 and SC11 (see FIG. 7), if no control is carried out for a given length of time while a session is established, the session is automatically released, preventing unnecessary engagement of the logical port.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

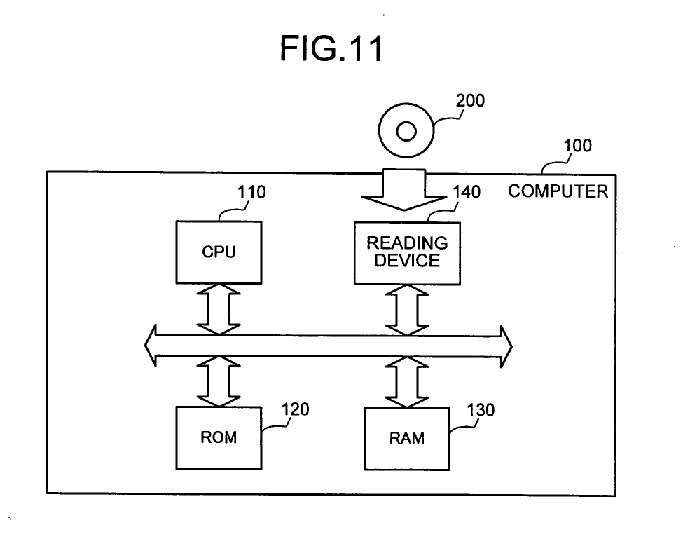

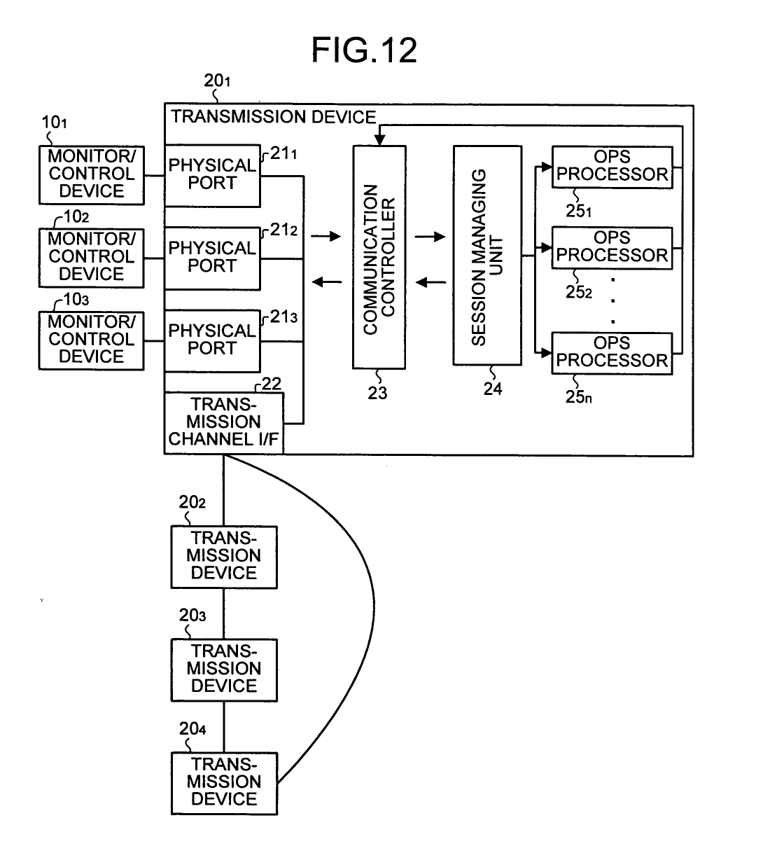

For instance, as shown in FIG. 11, a program that accomplishes the function (session management function) of the transmission devices 401 through 404 may be recorded on a computer-readable recording medium 200 and a computer 100 may read the program from the recording medium 200 and execute it.

The computer 100 includes a central processing unit (CPU) 110 that executes the program, a Read-Only Memory (ROM) 120 that stores various types of data, a Random Access Memory (RAM) 130 that stores calculation parameters, and a reading device 140 that reads the program from the recording medium 200.

The CPU 110 reads the program recorded on the recording medium 200 by means of the reading device 140 and executes the program to realize the functions described above. An optical disk, a flexible disk, a hard disk, and the like may be used as the recording medium.

Thus, according to the present invention, it is first determined whether a control frame that is received is from any of the monitor/control devices. If so, the source device ID and the source port ID (physical port ID as well as the logical port ID) of the physical port that receives the control frame and one of the plural logical ports provided for plural sessions in the physical port are appended to the control frame. If the control frame is meant for the local device, the process according to the control code is carried out. If the frame is meant for another transmission device, the source device ID and the source port ID are appended to the control frame, and the control frame is sent to the relevant transmission device. Thus, physically less space is required since only one physical port is used.

According to the present invention, upon receiving another control frame from the monitor/control device that already has a session established with a transmission device, the source port ID of the physical port and any of the free plural logical ports and the source device ID are appended to the control frame. Thus, plural sessions can be established per monitor control device.

According to the present invention, if no control is carried out for a given length of time while a session is established, the session is automatically released, preventing unnecessary engagement of the logical port.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1. A computer-readable recording medium that stores therein a computer program that causes a computer to execute:
receiving a frame that includes destination device information and control information;
determining whether the frame received is received from a monitor/control device, and appending, if it is determined that the frame received is received from the monitor/control device, port information and local device information to the frame, the port information being information pertaining to a physical port and one of a plurality of logical ports, the logical ports being provided corresponding to the physical port for establishing a plurality of sessions;
determining based on the destination device information in the frame whether a destination of the frame received is a local device or a device other than the local device, executing a process according to the control information if it is determined that the destination of the frame is the local device, and appending the port information and the local device information to the frame and transmitting the frame to the other device if it is determined that the destination of the frame is a device other than the local device.

2. The computer-readable recording medium according to claim 1, wherein when a second frame is received at the receiving from the monitor/control device that is in session, the appending includes appending to the second frame the port information and the local device information, the port information being information pertaining to the physical port and a different logical port from among the plurality of ports.

3. The computer-readable recording medium according to claim 1, wherein the computer program further causes the computer to automatically release an established session if no control operation is carried out for a given duration.

4. A session management method comprising:
receiving a frame that includes destination device information and control information;
determining whether the frame received is received from a monitor/control device, and appending, if it is determined that the frame received is received from the monitor/control device, port information and local device information to the frame, the port information being information pertaining to a physical port and one of a plurality of logical ports, the logical ports being provided corresponding to the physical port for establishing a plurality of sessions;
determining based on the destination device information in the frame whether a destination of the frame received is a local device or a device other than the local device, executing a process according to the control information if it is determined that the destination of the frame is the local device, and appending the port information and the local device information to the frame and transmitting the frame to the other device if it is determined that the destination of the frame is a device other than the local device.

5. The session management method according to claim 4, wherein when a second frame is received at the receiving from the monitor/control device that is in session, the appending includes appending to the second frame the port information and the local device information, the port information being information pertaining to the physical port and a different logical port from among the plurality of ports.

6. The session management method according to claim 4, further comprising automatically releasing an established session if no control operation is carried out for a given duration.

7. A session management apparatus comprising:
a receiving unit that receives a frame that includes destination device information and control information;
an appending unit that determines whether the frame received by the receiving unit is received from a monitor/control device, appends, if it is determined that the frame received is received from the monitor/control device, port information and local device information to the frame, the port information being information pertaining to a physical port and one of a plurality of logical ports, the logical ports being provided corresponding to the physical port for establishing a plurality of sessions; and
a control unit that determines based on the destination device information in the frame whether a destination of the frame received is a local device or a device other than the local device, executes a process according to the control information if it is determined that the destination of the frame is the local device, and appends the port information and the local device information to the frame and transmits the frame to the other device if it is determined that the destination of the frame is the device other than the local device.

8. The session management apparatus according to claim 7, wherein when the receiving unit receives a second frame from the monitor/control device that is in session, the appending unit appends to the second frame the port information and the local device information, the port information being information pertaining to the physical port and a different logical port from among the plurality of ports.

9. The session management apparatus according to claim 7, further comprising a session releasing unit that automatically releases an established session if no control operation is carried out for a given duration.
